(19) United States
(12) Patent Application Publication
(10) Pub. No.: US 2025/0187889 A1
(43) Pub. Date: Jun. 12, 2025

(54) LIFT AND MOBILE ROBOT HAVING THE SAME

(71) Applicant: SAMSUNG ELECTRONICS CO., LTD., Suwon-si (KR)

(72) Inventor: Kuemjong BAE, Suwon-si (KR)

(73) Assignee: SAMSUNG ELECTRONICS CO., LTD., Suwon-si (KR)

(21) Appl. No.: 19/018,722

(22) Filed: Jan. 13, 2025

Related U.S. Application Data
(63) Continuation of application No. PCT/KR2024/017320, filed on Nov. 5, 2024.

(30) Foreign Application Priority Data
Dec. 7, 2023 (KR) 10-2023-0176933

(51) Int. Cl. B66F 9/065; B66F 9/06; B66F 9/24

(52) U.S. Cl. CPC B66F 9/065; B66F 9/063; B66F 9/24

(57) ABSTRACT

A lift includes: a lifting block; a lifting groove on a lower surface of the lifting block and including first and second inclined surfaces; a first moving block configured to slide relative to the first inclined surface of the lifting groove and including a first moving inclined surface corresponding to the first inclined surface; a second moving block configured to slide relative to the second inclined surface of the lifting groove and including a second moving inclined surface corresponding to the second inclined surface; a drive device configured to simultaneously move the first and second moving blocks away from each other so that the lifting block rises or closer to each other so that the lifting block descends; and a base plate below the first and second moving blocks and configured to support the first moving block and the second moving block to move in a straight line.

### CROSS-REFERENCE TO RELATED APPLICATIONS

This application is a continuation application of International Application No. PCT/KR2024/017320, filed on Nov. 5, 2024, which is based on and claims priority to Korean Patent Application No. 10-2023-0176933, filed on Dec. 7, 2023, in the Korean Intellectual Property Office, the disclosures of which are incorporated by reference herein in their entireties.

### BACKGROUND

### 1. Field

The present disclosure relates to a lift and a mobile robot having the same.

### 2. Description of the Related Art

Mobile robots are widely used in various fields such as manufacturing, logistics, service, and the like.

For example, a mobile robot may transport various objects such as materials or parts to workers or consumers.

Mobile robots may include a lift that can adjust the height of an object to facilitate loading and unloading of the object.

The lift is disposed on an upper surface of the mobile robot, and may adjust the height of the object according to the height of the loading location and the height of the unloading location.

In particular, the mobile robot may move a heavy object loaded on the lift to the unloading location, and raise the heavy object with the lift to unload it at the unloading location.

### SUMMARY

According to an aspect of the disclosure, a lift may include: a lifting block; a lifting groove on a lower surface of the lifting block and including a first inclined surface and a second inclined surface, each of the first inclined surface and the second inclined surface being inclined relative to the lower surface of the lifting block and are symmetrical to each other; a first moving block configured to slide relative to the first inclined surface of the lifting groove and including a first moving inclined surface corresponding to the first inclined surface; a second moving block configured to slide relative to the second inclined surface of the lifting groove and including a second moving inclined surface corresponding to the second inclined surface; a drive device configured to simultaneously move the first moving block and the second moving block away from each other or closer to each other; and a base plate below the first moving block and the second moving block and configured to support the first moving block and the second moving block to move in a straight line. When the drive device causes the first moving block and the second moving block to move away from each other, the lifting block rises. When the drive device causes the first moving block and the second moving block to move closer to each other, the lifting block descends.

According to one or more embodiments of the disclosure, the lifting groove may have a cross-section of an isosceles trapezoid or an isosceles triangle.

According to one or more embodiments of the disclosure, the drive device may include: a bi-directional lead screw coupled with the first moving block and the second moving block; a motor configured to rotate the bi-directional lead screw; and a power transmitter between the motor and the bi-directional lead screw.

According to one or more embodiments of the disclosure, the drive device may further include a guide shaft parallel to the bi-directional lead screw between the first moving block and the second moving block.

According to one or more embodiments of the disclosure, the drive device may further include: a first guide shaft parallel to the bi-directional lead screw between the first moving block and the second moving block on one side of the bi-directional lead screw; and a second guide shaft parallel to the bi-directional lead screw between the first moving block and the second moving block on another side of the bi-directional lead screw.

According to one or more embodiments of the disclosure, the motor may include a brake.

According to one or more embodiments of the disclosure, the lift may further include: a pair of base guides, one of the pair of base guides being between the base plate and the first moving block and another of the pair of base guides being between the base plate and the second moving block.

According to one or more embodiments of the disclosure, the pair of base guides may each include a guide block and a guide rail. The guide block may be on a lower surface of the first moving block or a lower surface of the second moving block, and the guide rail may be on an upper surface of the base plate.

According to one or more embodiments of the disclosure, the lift may further include: a first inclined guide and a second inclined guide between the first inclined surface of the lifting groove and the first moving inclined surface of the first moving block; and a third inclined guide and a fourth inclined guide between the second inclined surface of the lifting groove and the second moving inclined surface of the second moving block.

According to one or more embodiments of the disclosure, the first inclined guide, the second inclined guide, the third inclined guide, and the fourth inclined guide may each include a guide block and a guide rail. The guide rail of each of the first inclined guide and the second inclined guide may be disposed on the first inclined surface and the guide rail of each of the third inclined guide and the fourth inclined guide is disposed on the second inclined surface of the lifting groove, and the guide block of each of the first inclined guide and the second inclined guide may be disposed on the first moving inclined surface of the first moving block and the guide block of each of the third inclined guide and the fourth inclined guide may be disposed on the second moving inclined surface of the second moving block.

According to one or more embodiments of the disclosure, the first inclined surface and the second inclined surface of the lifting groove may be respectively angled between 30 degrees and 45 degrees with respect to an upper surface of the lifting block.

According to one or more embodiments of the disclosure, the lift may further include: a slide plate on each of the first inclined surface and the second inclined surface of the lifting groove; and a moving slide plate on each of the first moving inclined surface of the first moving block and the second moving inclined surface of the second moving block.

According to another aspect of the disclosure, a mobile robot may include: a main body configured to drive autonomously; and a lift on an upper surface of the main body. The lift may include: a lifting block; a lifting groove on a lower surface of the lifting block and including a first inclined surface and a second inclined surface, each of the first inclined surface and the second inclined surface being inclined relative to the lower surface of the lifting block and are symmetrical to each other; a first moving block configured to slide relative to the first inclined surface of the lifting groove and including a first moving inclined surface corresponding to the first inclined surface; a second moving block configured to slide relative to the second inclined surface of the lifting groove and including a second moving inclined surface corresponding to the second inclined surface; a drive device configured to simultaneously move the first moving block and the second moving block away from each other or closer to each other; and a base plate below the first moving block and the second moving block and configured to support the first moving block and the second moving block to move in a straight line. When the drive device causes the first moving block and the second moving block to move away from each other, the lifting block rises. When the drive device causes the first moving block and the second moving block to move closer to each other, the lifting block descends.

According to one or more embodiments, the lifting groove may have a cross-section of an isosceles trapezoid or an isosceles triangle.

According to one or more embodiments, the drive device may include: a bi-directional lead screw coupled with the first moving block and the second moving block; a motor configured to rotate the bi-directional lead screw; and a power transmitter between the motor and the bi-directional lead screw.

According to one or more embodiments, the drive device may further include a guide shaft parallel to the bi-directional lead screw between the first moving block and the second moving block.

According to one or more embodiments, the drive device may further include: a first guide shaft parallel to the bi-directional lead screw between the first moving block and the second moving block on one side of the bi-directional lead screw; and a second guide shaft parallel to the bi-directional lead screw between the first moving block and the second moving block on another side of the bi-directional lead screw.

According to one or more embodiments, the mobile robot may further include: a pair of base guides, one of the pair of base guides being between the base plate and the first moving block and another of the pair of base guides being between the base plate and the second moving block. The pair of base guides each may include: a guide block on a lower surface of the first moving block or a lower surface of the second moving block; and a guide rail on an upper surface of the base plate.

According to one or more embodiments, the mobile robot may further include: a first inclined guide and a second inclined guide between the first inclined surface of the lifting groove and the first moving inclined surface of the first moving block; and a third inclined guide and a fourth inclined guide between the second inclined surface of the lifting groove and the second moving inclined surface of the second moving block.

According to one or more embodiments, the first inclined guide, the second inclined guide, the third inclined guide, and the fourth inclined guide may each include a guide block and a guide rail. The guide rail of each of the first inclined guide and the second inclined guide may be disposed on the first inclined surface and the guide rail of each of the third inclined guide and the fourth inclined guide is disposed on the second inclined surface of the lifting groove. The guide block of each of the first inclined guide and the second inclined guide may be disposed on the first moving inclined surface of the first moving block and the guide block of each of the third inclined guide and the fourth inclined guide may be disposed on the second moving inclined surface of the second moving block.

According to one or more embodiments, the first inclined surface and the second inclined surface of the lifting groove may respectively be angled between 30 degrees and 45 degrees with respect to an upper surface of the lifting block.

### BRIEF DESCRIPTION OF DRAWINGS

The above aspects, features, and advantages of certain embodiments of the disclosure will be more apparent from the following description taken in conjunction with the accompanying drawings.

FIG. 1 is a perspective view illustrating a lift according to one or more embodiments of the disclosure.

FIG. 2 is an exploded perspective view illustrating a lift according to one or more embodiments of the disclosure.

FIG. 3 is a cross-sectional view illustrating the lift of FIG. 1 taken along line A-A.

FIG. 4 is a cross-sectional view illustrating the lift of FIG. 1 taken along line B-B.

FIG. 5 is a perspective view illustrating a state in which a lifting block is removed from a lift according to one or more embodiments of the disclosure.

FIG. 6 is a bottom perspective view illustrating a lifting block of a lift according to one or more embodiments of the disclosure.

FIG. 7 is a front view illustrating a state in which a lifting block of a lift according to one or more embodiments of the disclosure is located at the lowest point.

FIG. 8 is a front view illustrating a state in which a lifting block of a lift according to one or more embodiments of the disclosure is located at the highest point.

FIG. 9 is a perspective view illustrating a state in which a lifting block of a lift according to one or more embodiments of the disclosure is located at the highest point.

FIG. 10 is a perspective view illustrating a state in which a lifting block is removed from a lift according to one or more embodiments of the disclosure.

FIG. 11 is a perspective view illustrating a state in which a lifting block is removed from a lift according to one or more embodiments of the disclosure.

FIG. 12 is a front view illustrating a lift according to one or more embodiments of the disclosure.

FIG. 13 is a perspective view illustrating a mobile robot having a lift according to one or more embodiments of the disclosure.

FIG. 14 is a front view illustrating a state in which a lifting plate of a mobile robot having a lift according to one or more embodiments of the disclosure is positioned at the lowest point.

FIG. 15 is a front view illustrating a state in which a lifting plate of a mobile robot having a lift according to one or more embodiments of the disclosure is positioned at the highest point.

FIG. 16 is a block diagram illustrating a mobile robot having a lift according to one or more embodiments of the disclosure.

### DETAILED DESCRIPTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, it means that the one component can be connected to the another component directly (e.g., wired), wirelessly, or through a third component.

Terms such as “include” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure relates to a lift capable of minimizing shaking of a lifting block and a load when the lifting block is raised, and a mobile robot including such a lift.

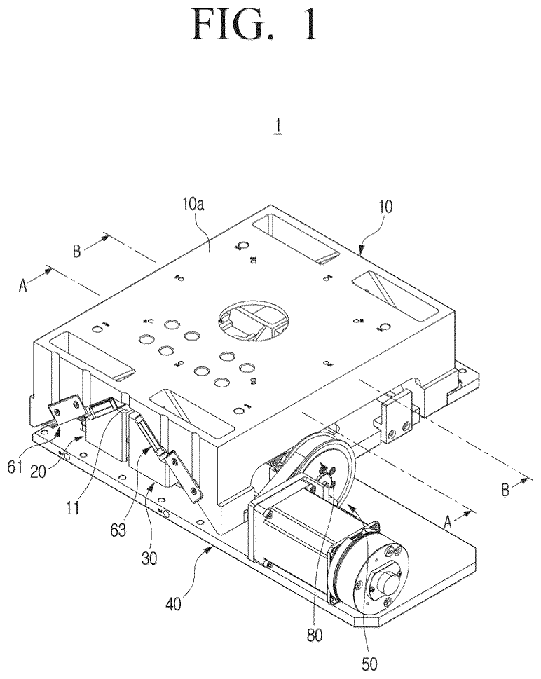

Hereinafter, a lift 1 according to one or more embodiments of the disclosure will be described with reference to FIGS. 1 to 5.

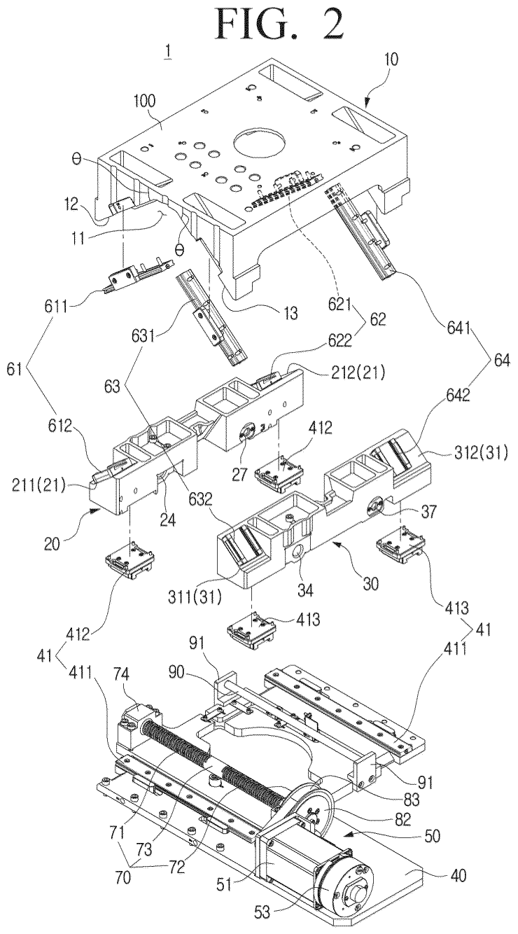

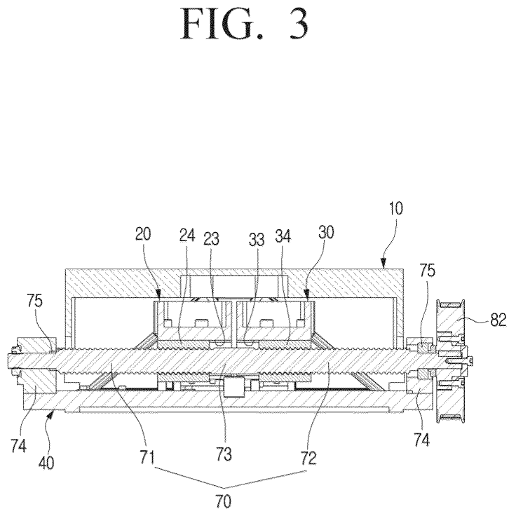

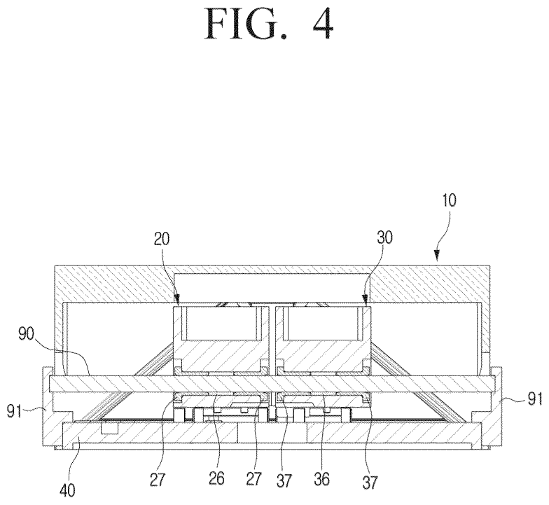

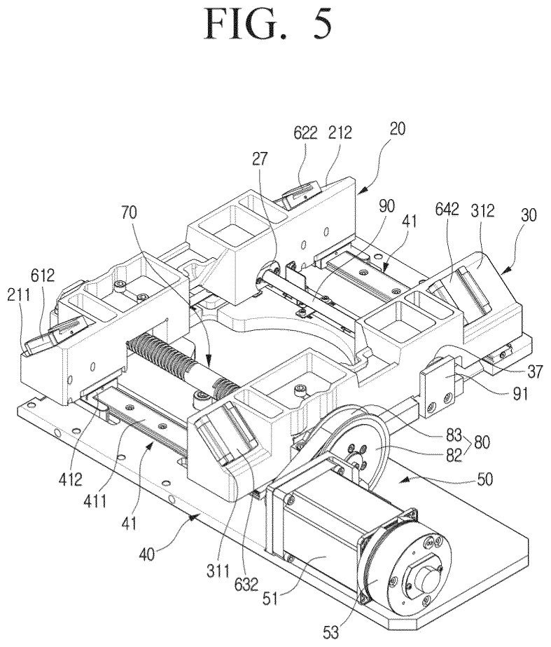

FIG. 1 is a perspective view illustrating a lift 1 according to one or more embodiments of the disclosure. FIG. 2 is an exploded perspective view illustrating a lift 1 according to one or more embodiments of the disclosure. FIG. 3 is a cross-sectional view illustrating the lift 1 of FIG. 1 taken along line A-A. FIG. 4 is a cross-sectional view illustrating the lift 1 of FIG. 1 taken along line B-B. FIG. 5 is a perspective view illustrating a state in which a lifting block 10 is removed from a lift 1 according to one or more embodiments of the disclosure.

Referring to FIGS. 1 to 5, a lift 1 according to one or more embodiments of the disclosure may include a lifting block 10, a first moving block 20, a second moving block 30, a base plate 40, and a drive device 50.

The lift 1 is configured to move an object loaded on an upper surface 10a of the lifting block 10 in a vertical direction by moving the lifting block 10 in a vertical direction relative to the bottom of the lift 1.

The lifting block 10 may be formed in an approximately rectangular parallelepiped shape. The upper surface 10a of the lifting block 10 may be formed as a plane. A lifting plate may be disposed on the upper surface 10a of the lifting block 10.

A lifting groove 11 may be formed on the lower surface of the lifting block 10. The lifting groove 11 may include a first inclined surface 12 and a second inclined surface 13 facing each other. The first inclined surface 12 and the second inclined surface 13 may be respectively formed on side surfaces of the lifting groove 11. The first inclined surface 12 and the second inclined surface 13 may be formed symmetrically to each other and inclined at a certain angle with respect to the upper surface 10a of the lifting block 10. For example, the lifting groove 11 may include the first inclined surface 12 and the second inclined surface 13 that are inclined with respect to the upper surface 10a of the lifting block 10 and are symmetrical to each other.

The first inclined surface 12 and the second inclined surface 13 of the lifting groove 11 may be formed to have the same inclination. For example, the first inclined surface 12 and the second inclined surface 13 may each be formed to have an angle θ of about 30 degrees to about 45 degrees with respect to the upper surface 10a of the lifting block 10.

The cross-section of the lifting groove 11 may be formed as an equilateral trapezoid or an isosceles triangle. Accordingly, the upper end of the first inclined surface 12 and the upper end of the second inclined surface 13 of the lifting groove 11 are adjacent to or in contact with each other at the center of the lifting block 10, and the lower end of the first inclined surface 12 and the lower end of the second inclined surface 13 are respectively adjacent to the side surfaces of the lifting block 10. In this embodiment of the disclosure, the lifting groove 11 is formed to have a cross-section of an equilateral trapezoid.

The first inclined surface 12 and the second inclined surface 13 of the lifting groove 11 may be formed on the lower surface of the lifting block 10 over the entire length of the lifting block 10. For example, the first inclined surface 12 and the second inclined surface 13 of the lifting groove 11 may be formed from the left end to the right end of the lower surface of the lifting block 10.

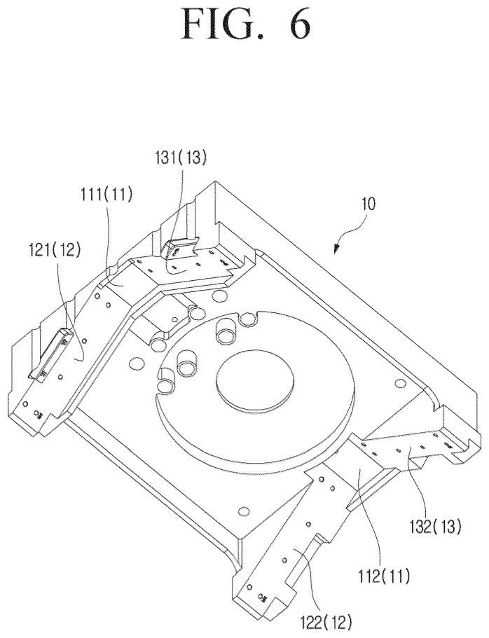

As another embodiment of the disclosure, as illustrated in FIG. 6, the first inclined surface 12 and the second inclined surface 13 of the lifting groove 11 may respectively be formed on side ends of the lower surface of the lifting block 10. For example, the first inclined surface 12 and the second inclined surface 13 of the lifting groove 11 may respectively be formed on the left end and the right end of the lower surface of the lifting block 10. The portion between the left end and the right end of the lower surface of the lifting block 10 may be removed. By forming the lifting groove 11 in this way, the weight of the lifting block 10 may be reduced.

FIG. 6 is a bottom perspective view illustrating a lifting block 10 of a lift 1 according to one or more embodiments of the disclosure.

Referring to FIG. 6, the lifting groove 11 may include a left lifting groove 111 and a right lifting groove 112 spaced apart from each other by a defined distance. For example, the lifting block 10 may include the left lifting groove 111 and the right lifting groove 112.

The first inclined surface 12 may include a first left inclined surface 121 and a first right inclined surface 122. The first left inclined surface 121 is formed in the left lifting groove 111, and the first right inclined surface 122 is formed in the right lifting groove 112. Therefore, the first left inclined surface 121 and the first right inclined surface 122 are spaced apart from each other by a defined distance.

The second inclined surface 13 may include a second left inclined surface 131 and a second right inclined surface 132. The second left inclined surface 131 is formed in the left lifting groove 111, and the second right inclined surface 132 is formed in the right lifting groove 112. Therefore, the second left inclined surface 131 and the second right inclined surface 132 are spaced apart from each other by a defined distance.

The second left inclined surface 131 is formed to face the first left inclined surface 121 and have the same slope as the first left inclined surface 121. The second right inclined surface 132 is formed to face the first right inclined surface 122 and have the same slope as the first right inclined surface 122.

The first left inclined surface 121 and the second left inclined surface 131 may form the left lifting groove 111. The first right inclined surface 122 and the second right inclined surface 132 may form the right lifting groove 112. In other words, the lifting block 10 may include the first left inclined surface 121, the second left inclined surface 131, the first right inclined surface 122, and the second right inclined surface 132 formed on the lower surface thereof.

Referring again to FIGS. 1 to 5, the first moving block 20 and the second moving block 30 may be disposed to be positioned in the lifting groove 11 of the lifting block 10. For example, the first moving block 20 and the second moving block 30 may be positioned in the lifting groove 11 below the lifting block 10. The first moving block 20 and the second moving block 30 may be formed to support the lifting block 10 and move the lifting block 10 in a vertical direction.

The first moving block 20 may be disposed so as to slide relative to the first inclined surface 12 of the lifting groove 11. The first moving block 20 may include a first moving inclined surface 21 corresponding to the first inclined surface 12 of the lifting groove 11.

The first moving block 20 may be formed in an approximately rectangular parallelepiped shape. The first moving block 20 may be formed to have a length corresponding to the lifting block 10.

When the first inclined surface 12 of the lifting block 10 is formed to include the first left inclined surface 121 and the first right inclined surface 122, the first moving inclined surface 21 of the first moving block 20 may include a first left moving inclined surface 211 and a first right moving inclined surface 212. The first left moving inclined surface 211 may be formed to correspond to the first left inclined surface 121, and the first right moving inclined surface 212 may be formed to correspond to the first right inclined surface 122.

Therefore, the first left moving inclined surface 211 of the first moving block 20 may slide along the first left inclined surface 121 of the lifting block 10, and the first right moving inclined surface 212 of the first moving block 20 may slide along the first right inclined surface 122 of the lifting block 10.

The second moving block 30 may be disposed so as to slide along the second inclined surface 13 of the lifting groove 11. The second moving block 30 may include a second moving inclined surface 31 corresponding to the second inclined surface 13 of the lifting groove 11.

The second moving block 30 may be formed in an approximately rectangular parallelepiped shape. The second moving block 30 may be formed to have a length corresponding to the lifting block 10. The second moving block 30 may be formed to have the same length as the first moving block 20. The second moving block 30 may be formed to have the same shape as the first moving block 20.

When the second inclined surface 13 of the lifting block 10 is formed to include the second left inclined surface 131 and the second right inclined surface 132, the second moving inclined surface 31 of the second moving block 30 may include a second left moving inclined surface 311 and a second right moving inclined surface 312. The second left moving inclined surface 311 may be formed to correspond to the second left inclined surface 131, and the second right moving inclined surface 312 may be formed to correspond to the second right inclined surface 132.

Therefore, the second left moving inclined surface 311 of the second moving block 30 may slide along the second left inclined surface 131 of the lifting block 10, and the second right moving inclined surface 312 of the second moving block 30 may slide along the second right inclined surface 132 of the lifting block 10.

A first inclined guide 61 and a second inclined guide 62 may be disposed between the first inclined surface 12 of the lifting groove 11 and the first moving inclined surface 21 of the first moving block 20. The first inclined guide 61 and the second inclined guide 62 may be disposed in parallel and spaced apart from each other by a certain distance.

For example, when the first inclined surface 12 of the lifting groove 11 includes the first left inclined surface 121 and the first right inclined surface 122, the first inclined guide 61 may be disposed between the first left inclined surface 121 of the lifting groove 11 and the first left moving inclined surface 211 of the first moving block 20, and the second inclined guide 62 may be disposed between the first right inclined surface 122 of the lifting groove 11 and the first right moving inclined surface 212 of the first moving block 20.

A third inclined guide 63 and a fourth inclined guide 64 may be disposed between the second inclined surface 13 of the lifting groove 11 and the second moving inclined surface 31 of the second moving block 30. The third inclined guide 63 and the fourth inclined guide 64 may be disposed in parallel and spaced apart from each other by a certain distance.

For example, when the second inclined surface 13 of the lifting groove 11 includes the second left inclined surface 131 and the second right inclined surface 132, the third inclined guide 63 may be disposed between the second left inclined surface 131 of the lifting groove 11 and the second left moving inclined surface 311 of the second moving block 30, and the fourth inclined guide 64 may be disposed between the second right inclined surface 132 of the lifting groove 11 and the second right moving inclined surface 312 of the second moving block 30.

The first, second, third, and fourth inclined guides 61, 62, 63, and 64 may each include a guide block and a guide rail. The guide rails may be disposed on the first inclined surface 12 and the second inclined surface 13 of the lifting groove 11, and the guide blocks may be disposed on the first moving inclined surface 21 of the first moving block 20 and the second moving inclined surface 31 of the second moving block 30.

For example, the first inclined guide 61 may include a first inclined guide rail 611 and a first inclined guide block 612, and the second inclined guide 62 may include a second inclined guide rail 621 and a second inclined guide block 622.

The first inclined guide rail 611 may be disposed on the first left inclined surface 121 of the lifting block 10, and the second inclined guide rail 621 may be disposed on the first right inclined surface 122 of the lifting block 10. The first inclined guide rail 611 and the second inclined guide rail 621 are spaced apart from each other by a certain distance and are disposed parallel to each other on the first inclined surface 12 of the lifting groove 11 of the lifting block 10.

The first inclined guide block 612 may be disposed on the first left moving inclined surface 211 of the first moving block 20, and the second inclined guide block 622 may be disposed on the first right moving inclined surface 212 of the first moving block 20. The first inclined guide block 612 and the second inclined guide block 622 are spaced apart from each other by a certain distance and disposed parallel to each other on the first moving inclined surface 21 of the first moving block 20.

The first inclined guide block 612 is disposed to slide on the first inclined guide rail 611. The second inclined guide block 622 is disposed to slide on the second inclined guide rail 621. Accordingly, the first moving block 20 may move in a straight line along the first inclined guide rail 611 and the second inclined guide rail 621 disposed on the first inclined surface 12 of the lifting block 10 by the first inclined guide block 612 and the second inclined guide block 622.

The third inclined guide 63 may include a third inclined guide rail 631 and a third inclined guide block 632, and the fourth inclined guide 64 may include a fourth inclined guide rail 641 and a fourth inclined guide block 642.

The third inclined guide rail 631 may be disposed on the second left inclined surface 131 of the lifting block 10, and the fourth inclined guide rail 641 may be disposed on the second right inclined surface 132 of the lifting block 10. The third inclined guide rail 631 and the fourth inclined guide rail 641 are spaced apart from each other by a certain distance and are disposed parallel to each other on the second inclined surface 13 of the lifting groove 11 of the lifting block 10.

The third inclined guide block 632 may be disposed on the second left moving inclined surface 311 of the second moving block 30, and the fourth inclined guide block 642 may be disposed on the second right moving inclined surface 312 of the second moving block 30. The third inclined guide block 632 and the fourth inclined guide block 642 are spaced apart from each other by a certain distance and disposed parallel to each other on the second moving inclined surface 31 of the second moving block 30.

The third inclined guide block 632 is disposed to slide on the third inclined guide rail 631. The fourth inclined guide block 642 is disposed to slide on the fourth inclined guide rail 641. Accordingly, the second moving block 30 may move in a straight line along the third inclined guide rail 631 and the fourth inclined guide rail 641 disposed on the second inclined surface 13 of the lifting block 10 by the third inclined guide block 632 and the fourth inclined guide block 642.

Therefore, the lifting block 10 may slide linearly up and down relative to the first moving block 20 and the second moving block 30 by the first, second, third, and fourth inclined guides 61, 62, 63, and 64.

The first moving block 20 and the second moving block 30 may be disposed on the upper surface of the base plate 40. The first moving block 20 and the second moving block 30 may be disposed to slide with respect to the upper surface of the base plate 40. The first moving block 20 and the second moving block 30 may move in a straight line.

The base plate 40 is disposed under the first moving block 20 and the second moving block 30, and may support the first moving block 20 and the second moving block 30 to move in a straight line.

The drive device 50 may be configured to move the first moving block 20 and the second moving block 30. The drive device 50 may be configured to simultaneously move the first moving block 20 and the second moving block 30 in opposite directions. The drive device 50 may be configured to move the first moving block 20 and the second moving block 30 in opposite directions the same distance. The first moving block 20 and the second moving block 30 may be moved in opposite directions in a straight line by the drive device 50.

When the first moving block 20 and the second moving block 30 move away from each other by the drive device 50, the lifting block 10 may rise. When the first moving block 20 and the second moving block 30 move closer to each other by the drive device 50, the lifting block 10 may descend.

The base plate 40 may be formed to support the first moving block 20, the second moving block 30, and the drive device 50.

A pair of base guides 41 may be disposed between the base plate 40 and the first moving block 20 and the second moving block 30. The pair of base guides 41 may support the first moving block 20 and the second moving block 30 to slide with respect to the base plate 40. The pair of base guides 41 are disposed in parallel on the upper surface of the base plate 40 and spaced apart from each other by a certain distance.

The pair of base guides 41 may each include a guide rail 411 and two guide blocks 412 and 413.

A pair of guide rails 411 are disposed on the upper surface of the base plate 40. The pair of guide rails 411 are spaced apart from each other by a certain distance and disposed parallel to each other.

The pair of guide blocks 412 and 413 may be disposed on the lower surface of the first moving block 20 or the second moving block 30.

For example, the pair of first guide blocks 412 may be disposed on the lower surface of the first moving block 20. The pair of first guide blocks 412 are disposed spaced apart from each other by the same distance as the pair of guide rails 411. The pair of first guide blocks 412 may be disposed below the first left inclined surface 121 and the first right inclined surface 122 of the first moving block 20.

The pair of first guide blocks 412 may be disposed to slide on the pair of guide rails 411. Therefore, the first moving block 20 may move in a straight line along the pair of guide rails 411 disposed on the base plate 40 by the pair of first guide blocks 412.

The pair of second guide blocks 413 may be disposed on the lower surface of the second moving block 30. The pair of second guide blocks 413 are disposed spaced apart from each other by the same distance as the pair of guide rails 411. The pair of second guide blocks 413 may be disposed below the second left inclined surface 131 and the second right inclined surface 132 of the second moving block 30.

The pair of second guide blocks 413 may be disposed to slide on the pair of guide rails 411. Therefore, the second moving block 30 may move in a straight line along the pair of guide rails 411 disposed on the base plate 40 by the pair of second guide blocks 413.

The first guide blocks 412 and the second guide block 413 are disposed to slide on a single guide rail 411.

The first moving block 20 and the second moving block 30 may slide relative to the upper surface of the base plate 40 by the pair of base guides 41.

The drive device 50 may include a bi-directional lead screw 70 and a motor 51.

The bi-directional lead screw 70 is formed to move the first moving block 20 and the second moving block 30 the same distance in opposite directions. The first moving block 20 and the second moving block 30 may move in opposite directions in a straight line by the bi-directional lead screw 70.

The bi-directional lead screw 70 may be disposed on the base plate 40. The bi-directional lead screw 70 is disposed to be supported at both ends on the upper surface of the base plate 40. For example, both ends of the bi-directional lead screw 70 may be rotatably supported by a pair of bearings 75. In other words, both ends of the bi-directional lead screw 70 may be supported by a pair of bearing blocks 74 disposed on the upper surface of the base plate 40. The bearing 75 is disposed in each of the pair of bearing blocks 74.

The bi-directional lead screw 70 is coupled with the first moving block 20 and the second moving block 30, and allows the first moving block 20 and the second moving block 30 to move a certain distance in opposite directions at the same time.

The bi-directional lead screw 70 includes a first male screw portion 71, a second male screw portion 72, and a central portion 73. The first male screw portion 71 and the second male screw portion 72 are formed on both sides of the central portion 73. The first male screw portion 71 and the second male screw portion 72 are formed with opposite spiral directions. For example, when the first male screw portion 71 is formed as a right-hand thread, the second male screw portion 72 may be formed as a left-hand thread.

The first moving block 20 is screw-connected to the first male screw portion 71 of the bi-directional lead screw 70, and the second moving block 30 is screw-connected to the second male screw portion 72. Therefore, when the bi-directional lead screw 70 rotates, the first moving block 20 and the second moving block 30 move linearly in opposite directions.

The first moving block 20 may include a first nut 24 that is screw-connected with the first male screw portion 71 of the bi-directional lead screw 70. The first nut 24 may be fixed to a nut hole 23 formed to penetrate the first moving block 20 in the width direction. When the bi-directional lead screw 70 rotates, the first nut 24 engaged with the first male screw portion 71 may move linearly along the bi-directional lead screw 70. When the first nut 24 moves, the first moving block 20 moves linearly along the bi-directional lead screw 70.

The second moving block 30 may include a second nut 34 that is screw-connected with the second male screw portion 72 of the bi-directional lead screw 70. The second nut 34 may be fixed to a nut hole 33 formed to penetrate the second moving block 30 in the width direction. When the bi-directional lead screw 70 rotates, the second nut 34 engaged with the second male screw portion 72 may move linearly along the bi-directional lead screw 70. When the second nut 34 moves, the second moving block 30 moves linearly along the bi-directional lead screw 70.

Because the spiral direction of the first male screw portion 71 and the spiral direction of the second male screw portion 72 are formed in opposite directions, when the bi-directional lead screw 70 rotates, the first nut 24 and the second nut 34 move in opposite directions. Accordingly, the first moving block 20 and the second moving block 30 also move in opposite directions.

The motor 51 is configured to rotate the bi-directional lead screw 70. The motor 51 may include a motor shaft 52 that rotates in both directions. When power is applied to the motor 51, the motor shaft 52 may rotate.

The motor 51 may include a brake 53. The brake 53 may be configured to block the rotation of the motor shaft 52 when power applied to the motor 51 is turned off. For example, the brake 53 may be configured to not operate when power is applied to the motor 51, and to operate when power is not applied to the motor 51. When the brake 53 operates, the motor shaft 52 may not rotate, and when the brake 53 does not operate, the motor shaft 52 may rotate.

The drive device 50 may include a power transmitter 80.

The power transmitter 80 may be disposed between the motor 51 and the bi-directional lead screw 70. The power transmitter 80 is configured to transmit the rotational force of the motor 51 to the bi-directional lead screw 70. The power transmitter 80 is configured to reduce the rotation speed of the motor 51 transmitted to the bi-directional lead screw 70 and increase the driving force. For example, the power transmitter 80 may be configured as a reducer.

One end of the bi-directional lead screw 70 and the motor shaft 52 of the motor 51 may be connected with the power transmitter 80.

In this embodiment of the disclosure, the power transmitter 80 includes a driving pulley 81, a driven pulley 82, and a belt 83. The driving pulley 81 is disposed on the motor 51, and the driven pulley 82 is disposed on the bi-directional lead screw 70. The belt 83 connects the driving pulley 81 and the driven pulley 82 so that the rotation of the driving pulley 81 is transmitted to the driven pulley 82.

For example, the driving pulley 81 is disposed on the motor shaft 52, and may rotate integrally with the motor shaft 52. The driven pulley 82 is disposed on one end of the bi-directional lead screw 70 and may rotate integrally with the bi-directional lead screw 70. The belt 83 is disposed to connect the driving pulley 81 and the driven pulley 82. Therefore, when the driving pulley 81 rotates, the driven pulley 82 is rotated.

A pitch circle diameter of the driven pulley 82 is formed to be larger than a pitch circle diameter of the driving pulley 81. Therefore, the rotation speed of the motor shaft 52 may be reduced and transmitted to the bi-directional lead screw 70.

In this embodiment of the disclosure, a belt power transmitter is used as the power transmitter 80, but the power transmitter 80 applied to the disclosure is not limited thereto. Various types of power transmitters may be used as the power transmitter 80. For example, a gear power transmitter may be used as the power transmitter 80.

The drive device 50 may include a guide shaft 90.

The guide shaft 90 may be disposed on the base plate 40. The guide shaft 90 may be disposed on the upper surface of the base plate 40 in parallel with the bi-directional lead screw 70. The guide shaft 90 is disposed to be supported at both ends thereof on the upper surface of the base plate 40. For example, both ends of the guide shaft 90 may be fixed by a pair of support brackets 91.

The guide shaft 90 is configured to guide the linear movement of the first moving block 20 and the second moving block 30. The first moving block 20 and the second moving block 30 may be disposed so as to slide along the guide shaft 90.

The first moving block 20 may include a pair of first guide bushes 27. The pair of first guide bushes 27 may be disposed in a bush hole 26 formed in the first moving block 20. The bush hole 26 may be formed to penetrate the first moving block 20. The bush hole 26 may be formed at a defined distance from the nut hole 23.

The pair of first guide bushes 27 may be disposed at both ends of the bush hole 26 of the first moving block 20. The pair of first guide bushes 27 may be configured to slide along the guide shaft 90. Accordingly, the first moving block 20 may slide along the guide shaft 90 disposed on the base plate 40 by the pair of first guide bushes 27.

The second moving block 30 may include a pair of second guide bushes 37. The pair of second guide bushes 37 may be disposed in a bush hole 36 formed in the second moving block 30. The bush hole 36 may be formed to penetrate the second moving block 30. The bush hole 36 may be formed at a defined distance from the nut hole 33.

The pair of second guide bushes 37 may be disposed at both ends of the bush hole 36 of the second moving block 30. The pair of second guide bushes 37 may be configured to slide along the guide shaft 90. Accordingly, the second moving block 30 may slide along the guide shaft 90 disposed on the base plate 40 by the pair of second guide bushes 37.

Therefore, the first moving block 20 and the second moving block 30 may move linearly along the guide shaft 90.

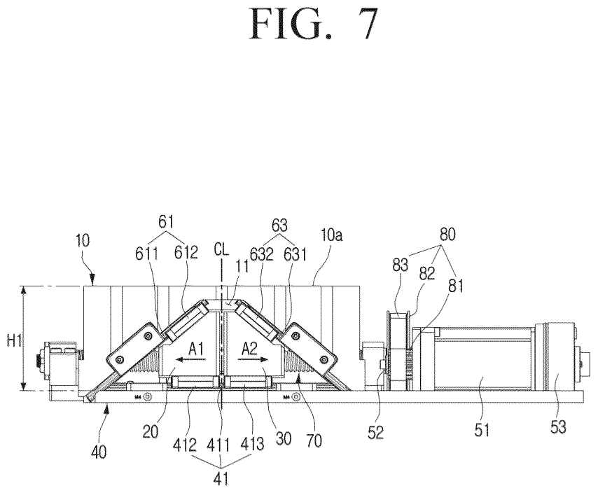

Hereinafter, the operation of the lift 1 according to one or more embodiments of the disclosure will be described with reference to FIGS. 7 to 9.

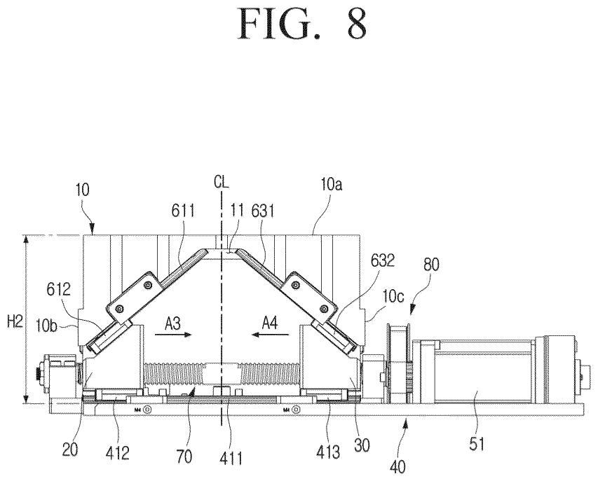

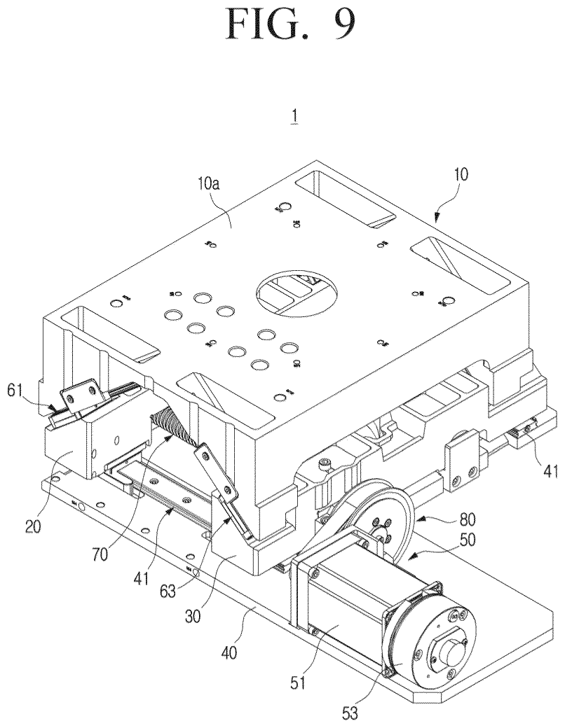

FIG. 7 is a front view illustrating a state in which a lifting block 10 of a lift 1 according to one or more embodiments of the disclosure is located at the lowest point. FIG. 8 is a front view illustrating a state in which a lifting block 10 of a lift 1 according to one or more embodiments of the disclosure is located at the highest point. FIG. 9 is a perspective view illustrating a state in which a lifting block 10 of a lift 1 according to one or more embodiments of the disclosure is located at the highest point.

Referring to FIGS. 1 and 7, the lifting block 10 of the lift 1 is positioned at the lowest point. In other words, the height H from the upper surface of the base plate 40 to the upper surface 10a of the lifting block 10 is the lowest. In this case, the first moving block 20 and the second moving block 30 are positioned adjacent to the center line CL of the lifting groove 11. In other words, the first moving block 20 and the second moving block 30 are positioned adjacent to the upper end of the lifting groove 11.

In detail, the first inclined guide block 612 disposed on one side of the first moving inclined surface 21 of the first moving block 20 is positioned adjacent to the upper end of the first inclined guide rail 611 disposed on one side of the first inclined surface 12 of the lifting block 10. In addition, the second inclined guide block 622 disposed on the other side of the first moving inclined surface 21 of the first moving block 20 is positioned adjacent to the upper end of the second inclined guide rail 621 disposed on the other side of the first inclined surface 12 of the lifting block 10.

The third inclined guide block 632 disposed on one side of the second moving inclined surface 31 of the second moving block 30 is positioned adjacent to the upper end of the third inclined guide rail 631 disposed on one side of the second inclined surface 13 of the lifting block 10. In addition, the fourth inclined guide block 642 disposed on the other side of the second moving inclined surface 31 of the second moving block 30 is positioned adjacent to the upper end of the fourth inclined guide rail 641 disposed on the other side of the second inclined surface 13 of the lifting block 10.

The pair of first guide blocks 412 disposed on the lower surface of the first moving block 20 and the pair of second guide blocks 413 disposed on the lower surface of the second moving block 30 are positioned adjacent to the center of the pair of guide rails 411 disposed on the base plate 40.

In other words, when the first moving block 20 and the second moving block 30 are positioned adjacent to the center line CL of the lifting groove 11, the first guide blocks 412 disposed on the first moving block 20 and the second guide blocks 413 disposed on the second moving block 30 are positioned closest to each other.

In this state, when power is applied to the motor 51, the motor shaft 52 rotates in one direction. When the motor shaft 52 rotates, the driving pulley 81 rotates integrally. The rotation of the motor shaft 52 is transmitted to the bi-directional lead screw 70 by the driving pulley 81, the belt 83, and the driven pulley 82, causing the bi-directional lead screw 70 to rotate in one direction.

When the bi-directional lead screw 70 rotates in one direction, the first nut 24 and the second nut 34 coupled to the first male screw portion 71 and the second male screw portion 72 of the bi-directional lead screw 70 move in opposite directions along the first male screw portion 71 and the second male screw portion 72 of the bi-directional lead screw 70. When the first nut 24 and the second nut 34 move in opposite directions, the first moving block 20 and the second moving block 30 move in opposite directions.

For example, in FIG. 7, when the first moving block 20 moves to the left (arrow A1), the second moving block 30 moves to the right (arrow A2) and moves away from the first moving block 20. At this time, the movements of the first moving block 20 and the second moving block 30 may be guided by the pair of base guides 41 disposed on the base plate 40.

For example, the first moving block 20 may move to the left (arrow A1) along the pair of guide rails 411 disposed on the base plate 40 by the pair of first guide blocks 412 disposed on the lower surface of the first moving block 20. The second moving block 30 may move to the right (arrow A2) along the pair of guide rails 411 disposed on the base plate 40 by the pair of second guide blocks 413 disposed on the lower surface of the second moving block 30.

When the first moving block 20 and the second moving block 30 move away from each other, the lifting block 10 disposed on the upper side of the first moving block 20 and the second moving block 30 rises. In other words, when the first moving block 20 and the second moving block 30 move away from each other, the lifting block 10 moves vertically upward with respect to the first moving block 20 and the second moving block 30.

The state in which the lifting block 10 is raised to the maximum, that is, the state in which the lifting block 10 is positioned at the highest height H2 is illustrated in FIGS. 8 and 9.

Referring to FIGS. 8 and 9, the lifting block 10 of the lift 1 is positioned at the highest point. In other words, the height H2 from the upper surface of the base plate 40 to the upper surface 10a of the lifting block 10 is the highest. At this time, the first moving block 20 and the second moving block 30 are positioned adjacent to both side surfaces 10b and 10c of the lifting block 10. In other words, the first moving block 20 and the second moving block 30 are positioned adjacent to the lower end of the lifting groove 11.

In detail, the first inclined guide block 612 disposed on one side of the first moving inclined surface 21 of the first moving block 20 is positioned adjacent to the lower end of the first inclined guide rail 611 disposed on one side of the first inclined surface 12 of the lifting block 10. In addition, the second inclined guide block 622 disposed on the other side of the first moving inclined surface 21 of the first moving block 20 is positioned adjacent to the lower end of the second inclined guide rail 621 disposed on the other side of the first inclined surface 12 of the lifting block 10.

The third inclined guide block 632 disposed on one side of the second moving inclined surface 31 of the second moving block 30 is positioned adjacent to the lower end of the third inclined guide rail 631 disposed on one side of the second inclined surface 13 of the lifting block 10. In addition, the fourth inclined guide block 642 disposed on the other side of the second moving inclined surface 31 of the second moving block 30 is positioned adjacent to the lower end of the fourth inclined guide rail 641 disposed on the other side of the second inclined surface 13 of the lifting block 10.

The pair of first guide blocks 412 disposed on the lower surface of the first moving block 20 and the pair of second guide blocks 413 disposed on the lower surface of the second moving block 30 are respectively positioned adjacent to ends of the pair of guide rails 411.

In other words, when the first moving block 20 and the second moving block 30 are respectively positioned adjacent to both side surfaces 10b and 10c of the lifting groove 11, the pair of first guide blocks 412 disposed on the first moving block 20 and the pair of second guide blocks 413 disposed on the second moving block 30 are positioned farthest from each other. For example, the pair of first guide blocks 412 are positioned adjacent to one ends of the pair of guide rails 411, and the pair of second guide blocks 413 are positioned adjacent to the other ends of the pair of guide rails 411. Accordingly, the first moving block 20 is positioned adjacent to one ends of the pair of guide rails 411, and the second moving block 30 is positioned adjacent to the other ends of the pair of guide rails 411.

In this state, when the motor shaft 52 is rotated in the opposite direction, the bi-directional lead screw 70 is rotated in the opposite direction by the power transmitter 80.

When the bi-directional lead screw 70 is rotated in the opposite direction, the first nut 24 and the second nut 34 coupled to the first male screw portion 71 and the second male screw portion 72 of the bi-directional lead screw 70 move in opposite directions along the first male screw portion 71 and the second male screw portion 72 of the bi-directional lead screw 70. When the first nut 24 and the second nut 34 move in opposite directions, the first moving block 20 and the second moving block 30 move in opposite directions.

For example, in FIG. 8, when the first moving block 20 moves to the right (arrow A3), the second moving block 30 moves to the left (arrow A4) and approaches the first moving block 20. At this time, the movements of the first moving block 20 and the second moving block 30 may be guided by the pair of base guides 41 disposed on the base plate 40.

When the first moving block 20 and the second moving block 30 come closer to each other, the lifting block 10 disposed on the upper side of the first moving block 20 and the second moving block 30 is lowered. In other words, when the first moving block 20 and the second moving block 30 move in the direction of coming closer to each other, the lifting block 10 moves downward in the vertical direction with respect to the first moving block 20 and the second moving block 30.

In the above, the case in which the drive device 50 includes one guide shaft 90 has been described, but the disclosure is not limited thereto.

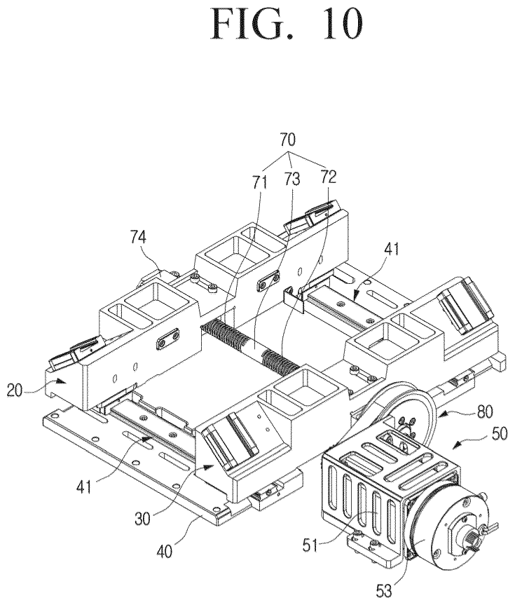

The drive device 50 of the lift 1 according to one or more embodiments of the disclosure may not include the guide shaft 90. Such a drive device 50 is illustrated in FIG. 10.

FIG. 10 is a perspective view illustrating a state in which a lifting block 10 is removed from a lift 1 according to one or more embodiments of the disclosure.

Referring to FIG. 10, the drive device 50 may include a bi-directional lead screw 70, a motor 51, and a power transmitter 80.

The bi-directional lead screw 70 may be disposed on the base plate 40. The bi-directional lead screw 70 is disposed to be supported at both ends on the upper surface of the base plate 40. For example, both ends of the bi-directional lead screw 70 may be supported by a pair of bearing blocks 74 disposed on the upper surface of the base plate 40. A bearing is disposed in each of the pair of bearing blocks 74.

The bi-directional lead screw 70 is coupled with the first moving block 20 and the second moving block 30, and may be configured to move the first moving block 20 and the second moving block 30 a certain distance in opposite directions at the same time.

The bi-directional lead screw 70 includes a first male screw portion 71, a second male screw portion 72, and a central portion 73. The first male screw portion 71 and the second male screw portion 72 are formed on both sides of the central portion 73. The first male screw portion 71 and the second male screw portion 72 are formed with opposite spiral directions. The first moving block 20 is screw-connected to the first male screw portion 71 of the bi-directional lead screw 70, and the second moving block 30 is screw-connected to the second male screw portion 72. Therefore, when the bi-directional lead screw 70 rotates, the first moving block 20 and the second moving block 30 move linearly in opposite directions.

The first moving block 20 may include a first nut 24 that is screw-connected with the first male screw portion 71 of the bi-directional lead screw 70. The first nut 24 may be fixed to a nut hole formed to penetrate the first moving block 20 in the width direction. The nut hole may be formed at the center of the length direction of the first moving block 20.

When the bi-directional lead screw 70 rotates, the first nut 24 engaged with the first male screw portion 71 may move linearly along the bi-directional lead screw 70. When the first nut 24 moves, the first moving block 20 moves linearly along the bi-directional lead screw 70.

The second moving block 30 may include a second nut 34 that is screw-connected with the second male screw portion 72 of the bi-directional lead screw 70. The second nut 34 may be fixed to a nut hole formed to penetrate the second moving block 30 in the width direction. The nut hole may be formed at the center of the length direction of the second moving block 30.

When the bi-directional lead screw 70 rotates, the second nut 34 engaged with the second male screw portion 72 may move linearly along the second male screw portion 72. When the second nut 34 moves, the second moving block 30 moves linearly along the bi-directional lead screw 70.

Because the spiral direction of the first male screw portion 71 and the spiral direction of the second male screw portion 72 are formed in opposite directions, when the bi-directional lead screw 70 rotates, the first nut 24 and the second nut 34 move in opposite directions. Accordingly, the first moving block 20 and the second moving block 30 also move in opposite directions.

The motor 51 is configured to rotate the bi-directional lead screw 70. The power transmitter 80 is configured to transmit the rotational force of the motor 51 to the bi-directional lead screw 70. The motor 51 and the power transmitter 80 are the same as or similar to the above-described embodiment of the disclosure; therefore, repeated descriptions thereof are omitted.

A pair of base guides 41 may be disposed on the lower side of the first moving block 20 and the second moving block 30. The pair of base guides 41 are the same as or similar to the above-described embodiment of the disclosure; therefore, a repeated description thereof is omitted.

A lifting block 10 may be disposed on the upper side of the first moving block 20 and the second moving block 30. The lifting block 10 may be formed in the same as or similar to the above-described embodiment of the disclosure, so a repeated description thereof is omitted.

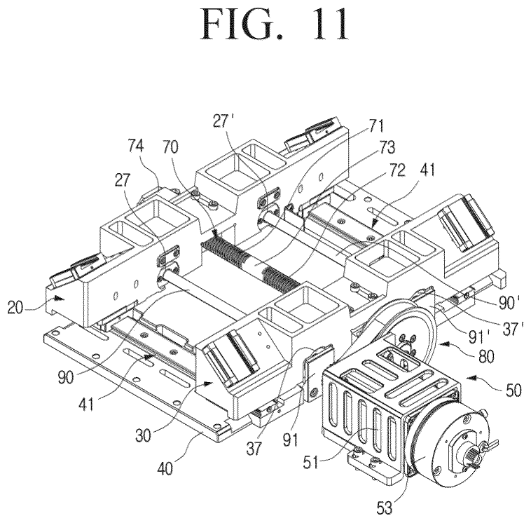

The drive device 50 of the lift 1 according to one or more embodiments of the disclosure may include two guide shafts. Such a drive device 50 is illustrated in FIG. 11.

FIG. 11 is a perspective view illustrating a state in which a lifting block 10 is removed from a lift 1 according to one or more embodiments of the disclosure.

Referring to FIG. 11, the drive device 50 may include a bi-directional lead screw 70, a motor 51, a power transmitter 80, a first guide shaft 90, and a second guide shaft 90′.

The bi-directional lead screw 70 may be disposed on the base plate 40. The bi-directional lead screw 70 is disposed to be supported at both ends on the upper surface of the base plate 40. For example, both ends of the bi-directional lead screw 70 may be supported by a pair of bearing blocks 74 disposed on the upper surface of the base plate 40. A bearing is disposed in each of the pair of bearing blocks 74.

The bi-directional lead screw 70 is coupled with the first moving block 20 and the second moving block 30, and may be configured to move the first moving block 20 and the second moving block 30 a certain distance in opposite directions at the same time.

The bi-directional lead screw 70 includes a first male screw portion 71, a second male screw portion 72, and a central portion 73. The first male screw portion 71 and the second male screw portion 72 are formed with opposite spiral directions. The first moving block 20 is screw-connected to the first male screw portion 71 of the bi-directional lead screw 70, and the second moving block 30 is screw-connected to the second male screw portion 72. Therefore, when the bi-directional lead screw 70 rotates, the first moving block 20 and the second moving block 30 move linearly in opposite directions.

The first moving block 20 may include a first nut 24 that is screw-connected with the first male screw portion 71 of the bi-directional lead screw 70. The first nut 24 may be fixed to a nut hole formed to penetrate the first moving block 20 in the width direction. The nut hole may be formed at the center of the length direction of the first moving block 20.

When the bi-directional lead screw 70 rotates, the first nut 24 engaged with the first male screw portion 71 may move linearly along the first male screw portion 71 of the bi-directional lead screw 70. When the first nut 24 moves, the first moving block 20 moves linearly along the bi-directional lead screw 70.

The second moving block 30 may include a second nut 34 that is screw-connected with the second male screw portion 72 of the bi-directional lead screw 70. The second nut 34 may be fixed to a nut hole formed to penetrate the second moving block 30 in the width direction. The nut hole may be formed at the center of the length direction of the second moving block 30.

When the bi-directional lead screw 70 rotates, the second nut 34 engaged with the second male screw portion 72 may move linearly along the second male screw portion 72 of the bi-directional lead screw 70. When the second nut 34 moves, the second moving block 30 moves linearly along the bi-directional lead screw 70.

Because the spiral direction of the first male screw portion 71 and the spiral direction of the second male screw portion 72 are formed in opposite directions, when the bi-directional lead screw 70 rotates, the first nut 24 and the second nut 34 move in opposite directions. Accordingly, the first moving block 20 and the second moving block 30 also move in opposite directions.

The motor 51 is configured to rotate the bi-directional lead screw 70. The power transmitter 80 is configured to transmit the rotational force of the motor 51 to the bi-directional lead screw 70. The motor 51 and the power transmitter 80 are the same as or similar to the above-described embodiment of the disclosure; therefore, repeated descriptions thereof are omitted.

The first guide shaft 90 and the second guide shaft 90′ may be disposed on the base plate 40. The first guide shaft 90 and the second guide shaft 90′ may be disposed symmetrically on both sides of the bi-directional lead screw 70. The first guide shaft 90 and the second guide shaft 90′ may be disposed on the upper surface of the base plate 40 parallel to the bi-directional lead screw 70.

Each of the first guide shaft 90 and the second guide shaft 90′ is supported at both ends thereof on the upper surface of the base plate 40. For example, both ends of the first guide shaft 90 and both ends of the second guide shaft 90′ may respectively be fixed by a pair of support brackets 91 and 91′.

The first guide shaft 90 and the second guide shaft 90′ are formed to guide the linear movements of the first moving block 20 and the second moving block 30, respectively. The first moving block 20 and the second moving block 30 may be disposed to slide along the first guide shaft 90 and the second guide shaft 90′.

The first moving block 20 may include two bush holes. The two bush holes may be formed on both sides of the nut hole. The two bush holes may be formed at a certain distance apart from the nut hole. The two bush holes may be formed to penetrate the first moving block 20.

The first moving block 20 may include two pairs of first guide bushes 27 and 27′ disposed in the two bush holes. A pair of first guide bushes 27 and 27′ may be disposed at both ends of one bush hole.

The two pairs of first guide bushes 27 and 27′ may be formed to slide along the first guide shaft 90 and the second guide shaft 90′. Therefore, the first moving block 20 may slide along the first guide shaft 90 and the second guide shaft 90′ by the two pairs of first guide bushes 27 and 27′.

The second moving block 30 may include two bush holes. The two bush holes may be formed on both sides of the nut hole. The two bush holes may be formed at a certain distance apart from the nut hole. The two bush holes may be formed to penetrate the second moving block 30.

The second moving block 30 may include two pairs of second guide bushes 37 and 37′ disposed in the two bush holes. A pair of second guide bushes 37 and 37′ may be disposed at both ends of one bush hole.

The two pairs of second guide bushes 37 and 37′ may be formed to slide along the first guide shaft 90 and the second guide shaft 90′. Therefore, the second moving block 30 may slide along the first guide shaft 90 and the second guide shaft 90′ by the two pairs of second guide bushes 37 and 37′.

Therefore, when the bi-directional lead screw 70 rotates, the first moving block 20 and the second moving block 30 may move linearly along the first guide shaft 90 and the second guide shaft 90′.

A pair of base guides 41 may be disposed on the lower side of the first moving block 20 and the second moving block 30. The pair of base guides 41 are the same as or similar to the above-described embodiment of the disclosure; therefore, a repeated description thereof is omitted.

A lifting block 10 may be disposed on the upper side of the first moving block 20 and the second moving block 30. The lifting block 10 may be formed in the same as or similar to the above-described embodiment of the disclosure, so a repeated description thereof is omitted.

In the above description, the sliding movement between the lifting block 10 and the first moving block 20 and the sliding movement between the lifting block 10 and the second moving block 30 are performed by the guide. However, in the lift 1 according to one or more embodiments of the disclosure, performing sliding movement between the lifting block 10 and the moving blocks 20 and 30 is not limited to the guides. Various sliding methods may be applied.

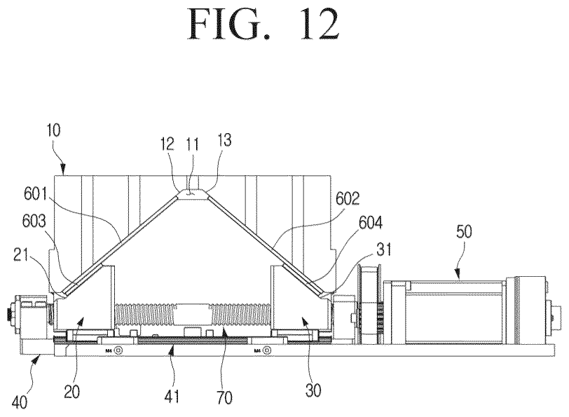

For example, the sliding movement between the lifting block 10 and the first moving block 20 and the sliding movement between the lifting block 10 and the second moving block 30 may be performed by a sliding plate. Such a lift 1 is illustrated in FIG. 12.

FIG. 12 is a front view illustrating a lift 1 according to one or more embodiments of the disclosure.

Referring to FIG. 12, a lift 1 according to one or more embodiments of the disclosure may include a lifting block 10, a first moving block 20, a second moving block 30, a base plate 40, and a drive device 50.

The lifting block 10 according to this embodiment of the disclosure includes a first inclined surface 12 and a second inclined surface 13 formed on the lifting groove 11. A first slide plate 601 is disposed on the first inclined surface 12, and a second slide plate 602 is disposed on the second inclined surface 13.

A first moving slide plate 603 is disposed on the first moving inclined surface 21 of the first moving block 20. The first moving slide plate 603 of the first moving block 20 is formed to slide with respect to the first slide plate 601 of the first inclined surface 12 of the lifting block 10.

A second moving slide plate 604 is disposed on the second moving inclined surface 31 of the second moving block 30. The second moving slide plate 604 of the second moving block 30 is formed to slide with respect to the second slide plate 602 of the second inclined surface 13 of the lifting block 10.

The first slide plate 601, the second slide plate 602, the first moving slide plate 603, and the second moving slide plate 604 may be formed of a material having low friction. For example, the first slide plate 601, the second slide plate 602, the first moving slide plate 603, and the second moving slide plate 604 may be formed of Teflon.

The first slide plate 601, the second slide plate 602, the first moving slide plate 603, and the second moving slide plate 604 may be formed in a thin flat plate shape.

The other structures of the lifting block 10, the first moving block 20, and the second moving block 30 are the same as or similar to those of the above-described embodiment of the disclosure, so repeated descriptions thereof are omitted.

The base plate 40 and the drive device 50 are the same as or similar to those of the above-described embodiment of the disclosure, so repeated descriptions thereof are omitted.

As another example, the first slide plate 601 and the first moving slide plate 603 may be formed as a slide rail structure. In addition, the second slide plate 602 and the second moving slide plate 604 may be formed as a slide rail structure.

As another example, the first inclined surface 12 and the second inclined surface 13 of the lifting block 10, the first moving inclined surface 21 of the first moving block 20, and the second moving inclined surface 31 of the second moving block 30 may be surface-treated to enable sliding.

In addition, a lubricating material, a non-lubricating tape, grease, paint, etc. may be applied to minimize friction between the first inclined surface 12 of the lifting block 10 and the first moving inclined surface 21 of the first moving block 20 and between the second inclined surface 13 of the lifting block 10 and the second moving inclined surface 31 of the second moving block 30.

In the lift 1 according to one or more embodiments of the disclosure having the structure as described above, when the lifting block 10 is at its highest height, the first moving block 20 and the second moving block 30 are spaced the farthest from each other in the horizontal direction at the lower end of the lifting block 10 to stably support the lifting block 10, so that shaking of the lifting block 10 may be minimized. Accordingly, the lift 1 according to one or more embodiments of the disclosure may minimize shaking of the lifting block 10 and the load when the lifting block 10 rises.

In addition, the lift 1 according to one or more embodiments of the disclosure raises and lowers the lifting block 10 using the bi-directional lead screw 70, so that the lifting block 10 may be prevented from descending by its own weight when the power is turned off.

The lift 1 according to one or more embodiments of the disclosure having the above-described structure may be disposed on a mobile robot 100.

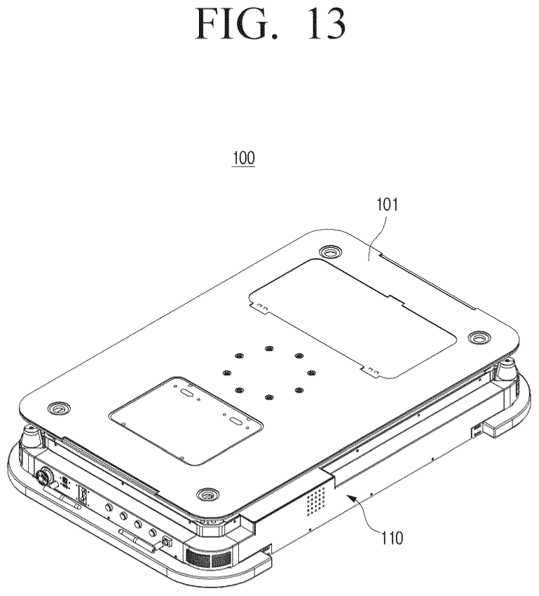

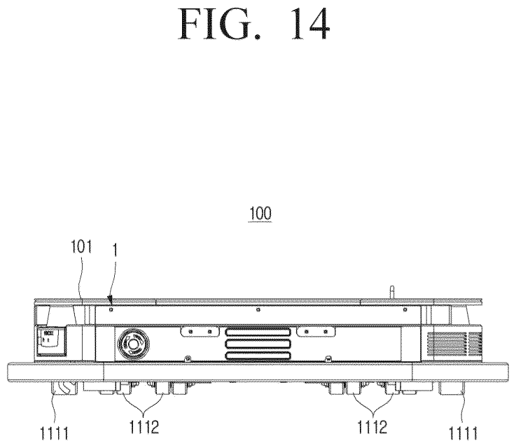

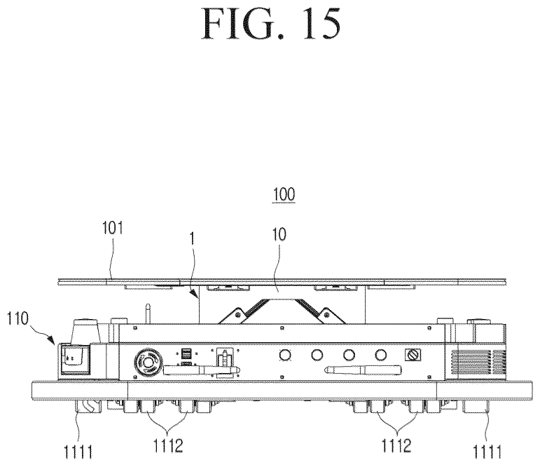

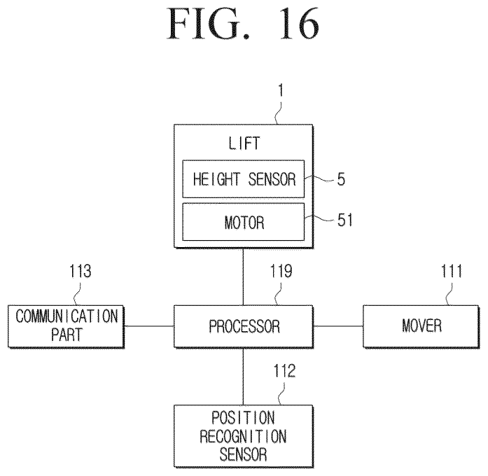

FIG. 13 is a perspective view illustrating a mobile robot 100 having a lift 1 according to one or more embodiments of the disclosure. FIG. 14 is a front view illustrating a state in which a lifting plate of a mobile robot 100 having a lift 1 according to one or more embodiments of the disclosure is positioned at the lowest point. FIG. 15 is a front view illustrating a state in which a lifting plate of a mobile robot 100 having a lift 1 according to one or more embodiments of the disclosure is positioned at the highest point. FIG. 16 is a block diagram illustrating a mobile robot 100 having a lift 1 according to one or more embodiments of the disclosure.

Referring to FIGS. 13 to 16, a mobile robot 100 according to one or more embodiments of the disclosure may include a main body 110 and a lift 1.

The lift 1 is disposed on the upper surface of the main body 110. When the base plate 40 is fixed to the upper surface of the main body 110, the lift 1 may be disposed on the main body 110.

The lift 1 may include a height sensor 5 capable of identifying when the lifting block 10 is at the highest point and when the lifting block 10 is at the lowest point.

A lifting plate 101 may be disposed on the upper surface of the lift 1, that is, the upper surface 10a of the lifting block 10. The lifting plate 101 may be formed to have a size and shape corresponding to the upper surface of the main body 110. For example, the lifting plate 101 may be formed as an approximately rectangular flat plate. The lifting plate 101 may be disposed on the upper surface of the lifting block 10 with a plurality of bolts.

The main body 110 may be configured to move the lift 1 to a designated location. In other words, the lift 1 may move to a designated location by autonomous driving of the main body 110.

The main body 110 may include a mover 111, a position recognition sensor 112, a communication part 113, and a processor 119.

The mover 111 may be configured to move the mobile robot 100 on the traveling surface. For example, the mover 111 may include a pair of driving wheels 1111 and a plurality of auxiliary wheels 1112. The pair of driving wheels 1111 and the plurality of auxiliary wheels 1112 may be disposed on the lower surface of the main body 110. The pair of driving wheels 1111 may be rotatably disposed on the left and right sides of the lower surface of the main body 110. The plurality of auxiliary wheels 1112 may be disposed on the front and rear of the pair of driving wheels 1111.

However, the structure of the mover 111 is not limited to the plurality of wheels. Various structures of movers may be used as long as they can move the mobile robot 100.

The position recognition sensor 112 is configured so that the mobile robot 100 may recognize its own position. The mobile robot 100 may recognize its own position using the position recognition sensor 112. For example, a sensor capable of recognizing the current position of the mobile robot 100, such as an image sensor, a LiDAR sensor, and the like, may be used as the position recognition sensor 112.

The communication part 113 may be configured to wirelessly communicate with external devices such as a server, a mobile device, etc. For example, the communication part 113 may receive information about the location of the destination and the height of the destination from the external device.

The communication part 113 may be wirelessly connected to the external device by various communication methods such as Bluetooth, WiFi, 4G, 5G, etc.

The processor 119 is configured to control the mobile robot 100. For example, the processor 119 may be configured to control the mover 111, the position recognition sensor 112, the lift 1, and the communication part 113.

The processor 119 may control the mover 111 to move the mobile robot 100. The processor 119 may recognize the current position of the mobile robot 100 using the position recognition sensor 112. The processor 119 may move the mobile robot 100 to the destination using the position recognition sensor 112 and the mover 111.

The processor 119 may control the motor 51 of the lift 1 to adjust the height of the lifting plate 101. The processor 119 may identify whether the lifting block 10 is at the highest point or the lowest point through the height sensor 5.

For example, when the mobile robot 100 is moving, the processor 119 may control the lift 1 so that the lifting plate 101 is at the lowest height. In other words, the processor 119 may control the motor 51 of the lift 1 so that the lifting block 10 is at the lowest point as illustrated in FIG. 14.

When the mobile robot 100 arrives at the destination, the processor 119 may control the lift 1 so that the height of the lifting plate 101 matches the height of the destination. For example, as illustrated in FIG. 15, the processor 119 may control the motor 51 of the lift 1 so that the lifting block 10 is positioned at the highest point.

The processor 119 may be a central processing unit (CPU), an application processor unit (APU), a graphics processing unit (GPU), a neural processing unit (NPU), an image signal processor (ISP), a sensor hub processor, or a communication processor (CP), and a hardware accelerator configured to perform functions and operations described by software or software module stored in one or more memories included therein or an external memory device.

The memory may store various data used by the processor 119. The various data may include software and input data or output data for a command related thereto. The memory may include the volatile memory or the non-volatile memory or both volatile memory and the non-volatile memory.

In the foregoing, the disclosure has been shown and described with reference to various embodiments. However, it is understood by those skilled in the art that various changes may be made in form and detail without departing from the spirit and scope of the disclosure as defined by the appended claims and equivalents thereof.

What is claimed is:

1. A lift comprising:
a lifting block;
a lifting groove on a lower surface of the lifting block and comprising a first inclined surface and a second inclined surface, each of the first inclined surface and the second inclined surface being inclined relative to the lower surface of the lifting block and symmetrical to each other;
a first moving block configured to slide relative to the first inclined surface of the lifting groove and comprising a first moving inclined surface corresponding to the first inclined surface;
a second moving block configured to slide relative to the second inclined surface of the lifting groove and comprising a second moving inclined surface corresponding to the second inclined surface;
a drive device configured to simultaneously move the first moving block and the second moving block away from each other or closer to each other; and
a base plate below the first moving block and the second moving block and configured to support the first moving block and the second moving block to move in a straight line,
wherein, in a case where the drive device causes the first moving block and the second moving block to move away from each other, the lifting block rises, and
wherein, in a case where the drive device causes the first moving block and the second moving block to move closer to each other, the lifting block descends.

2. The lift of claim 1, wherein the lifting groove has a cross-section of an isosceles trapezoid or an isosceles triangle.

3. The lift of claim 1, wherein the drive device comprises:
a bi-directional lead screw coupled with the first moving block and the second moving block;
a motor configured to rotate the bi-directional lead screw; and
a power transmitter between the motor and the bi-directional lead screw.

4. The lift of claim 3, wherein the drive device further comprises a guide shaft parallel to the bi-directional lead screw between the first moving block and the second moving block.

5. The lift of claim 3, wherein the drive device further comprises:
a first guide shaft parallel to the bi-directional lead screw between the first moving block and the second moving block on one side of the bi-directional lead screw; and
a second guide shaft parallel to the bi-directional lead screw between the first moving block and the second moving block on another side of the bi-directional lead screw.

6. The lift of claim 3, wherein the motor comprises a brake.

7. The lift of claim 1, further comprising:
a pair of base guides, one of the pair of base guides being between the base plate and the first moving block and another of the pair of base guides being between the base plate and the second moving block.

8. The lift of claim 7, wherein the pair of base guides each comprise:
a guide block on a lower surface of the first moving block or a lower surface of the second moving block; and
a guide rail on an upper surface of the base plate.

9. The lift of claim 1, further comprising:
a first inclined guide and a second inclined guide between the first inclined surface of the lifting groove and the first moving inclined surface of the first moving block; and
a third inclined guide and a fourth inclined guide between the second inclined surface of the lifting groove and the second moving inclined surface of the second moving block.

10. The lift of claim 9, wherein
the first inclined guide, the second inclined guide, the third inclined guide, and the fourth inclined guide each comprise a guide block and a guide rail,
wherein the guide rail of each of the first inclined guide and the second inclined guide is disposed on the first inclined surface and the guide rail of each of the third inclined guide and the fourth inclined guide is disposed on the second inclined surface of the lifting groove, and
wherein the guide block of each of the first inclined guide and the second inclined guide is disposed on the first moving inclined surface of the first moving block and the guide block of each of the third inclined guide and the fourth inclined guide is disposed on the second moving inclined surface of the second moving block.

11. The lift of claim 1, wherein the first inclined surface and the second inclined surface of the lifting groove are respectively angled between 30 degrees and 45 degrees with respect to an upper surface of the lifting block.

12. The lift of claim 1, further comprising:
a slide plate on each of the first inclined surface and the second inclined surface of the lifting groove; and
a moving slide plate on each of the first moving inclined surface of the first moving block and the second moving inclined surface of the second moving block.

13. A mobile robot comprising:
a main body configured to drive autonomously; and
a lift on an upper surface of the main body,
wherein the lift comprises:
a lifting block;
a lifting groove on a lower surface of the lifting block and comprising a first inclined surface and a second inclined surface, each of the first inclined surface and the second inclined surface being inclined relative to the lower surface of the lifting block and symmetrical to each other;
a first moving block configured to slide relative to the first inclined surface of the lifting groove and comprising a first moving inclined surface corresponding to the first inclined surface;
a second moving block configured to slide relative to the second inclined surface of the lifting groove and comprising a second moving inclined surface corresponding to the second inclined surface;
a drive device configured to simultaneously move the first moving block and the second moving block away from each other or closer to each other; and
a base plate below the first moving block and the second moving block and configured to support the first moving block and the second moving block to move in a straight line,
wherein, in a case where the drive device causes the first moving block and the second moving block to move away from each other, the lifting block rises, and
wherein, in a case where the drive device causes the first moving block and the second moving block to move closer to each other, the lifting block descends.

14. The mobile robot of claim 13, wherein the lifting groove has a cross-section of an isosceles trapezoid or an isosceles triangle.

15. The mobile robot of claim 13, wherein the drive device comprises:
a bi-directional lead screw coupled with the first moving block and the second moving block;
a motor configured to rotate the bi-directional lead screw; and
a power transmitter between the motor and the bi-directional lead screw.

16. The mobile robot of claim 15, wherein the drive device further comprises a guide shaft parallel to the bi-directional lead screw between the first moving block and the second moving block.

17. The mobile robot of claim 15, wherein the drive device further comprises:
a first guide shaft parallel to the bi-directional lead screw between the first moving block and the second moving block on one side of the bi-directional lead screw; and
a second guide shaft parallel to the bi-directional lead screw between the first moving block and the second moving block on another side of the bi-directional lead screw.

18. The mobile robot of claim 13, further comprising:
a pair of base guides, one of the pair of base guides being between the base plate and the first moving block and another of the pair of base guides being between the base plate and the second moving block,
wherein the pair of base guides each comprise:
a guide block on a lower surface of the first moving block or a lower surface of the second moving block; and
a guide rail on an upper surface of the base plate.

19. The mobile robot of claim 13, further comprising:
a first inclined guide and a second inclined guide between the first inclined surface of the lifting groove and the first moving inclined surface of the first moving block; and
a third inclined guide and a fourth inclined guide between the second inclined surface of the lifting groove and the second moving inclined surface of the second moving block,
wherein the first inclined guide, the second inclined guide, the third inclined guide, and the fourth inclined guide each comprise a guide block and a guide rail,
wherein the guide rail of each of the first inclined guide and the second inclined guide is disposed on the first inclined surface and the guide rail of each of the third inclined guide and the fourth inclined guide is disposed on the second inclined surface of the lifting groove, and
wherein the guide block of each of the first inclined guide and the second inclined guide is disposed on the first moving inclined surface of the first moving block and the guide block of each of the third inclined guide and the fourth inclined guide is disposed on the second moving inclined surface of the second moving block.

20. The mobile robot of claim 13, the first inclined surface and the second inclined surface of the lifting groove are respectively angled between 30 degrees and 45 degrees with respect to an upper surface of the lifting block.
